(19) United States
(12) Patent Application Publication
(10) Pub. No.: US 2008/0313963 A1
(43) Pub. Date: Dec. 25, 2008

(54) Window Element, a Profiled Pultruded Panel, a System of a Profiled Pultruded Panel and One or More Fixation Elements, a Covering of a Buidling or a House, a Building or a House, a Method of Providing an Outer Weather Resistant Covering, and a Building Element

(75) Inventor: Henrik Thorning, Kolding (DK)

Correspondence Address: KLEIN, O'NEILL & SINGH, LLP, 43 CORPORATE PARK, SUITE 204, IRVINE, CA, 92606, US

(73) Assignee: FIBERLINE A/S, Middelfart (DK)

(21) Appl. No.: 12/089,458

(22) PCT Filed: Oct. 9, 2006
(86) PCT No.: PCT/DK2006/000570

§ 371 Date: Jul. 22, 2008

(30) Foreign Application Priority Data
Oct. 7, 2005 (EP) 05388084.5
May 11, 2006 (EP) 06388034.8

(51) Int. Cl. E06B 3/964; E06B 7/00

(52) U.S. Cl. 49/383; 52/204.62; 52/204.66; 264/257

(57) ABSTRACT

A window element includes an outer window pane defining first and second sets of parallel sides; an inner window pane defining an inner window face; first and second sets of pultruded elements extending along the first and second sets of parallel sides, respectively and connecting the outer and inner panes in a window structure; a window frame of profiled pultruded elements surrounding the window structure; first and second co-operating hinged parts, the first part adhered to the window structure at a first edge parallel with one of the sides of the first set of sides, the second part provided by one of the profiled pultruded elements; and closure elements adhered to the inner window face at a second edge parallel with another side of the first set of sides and co-operating with recesses in an adjacent profiled pultruded element for arresting the window structure in a closed state.

The present invention generally relates to the technical field of houses and buildings and techniques of building houses and buildings and more particularly relates to novel window elements and panels to be used for wall covering and novel techniques for providing an outer weather resistant covering of a building.

Through the last century, numerous techniques have been developed within the technical filed of building houses and constructing buildings involving window elements and covering or facing elements such as high insulating windows including glazed windows, and furthermore certain techniques of constructing building elements or window elements have been developed by the applicant company such as the techniques described in applicant's published international patent application WO/2005/066444.

A window element to be used in a house or a building has to combine a number of different and sometimes conflicting requirements such as a maximum aperture for allowing light to be introduced into the building or housing and at the same time provide a maximum insulation which in the major part of the industrialised world serve to reduce the transmission of heat from the interior of the building or housing to the environment although in certain specific countries the insulating properties serve to reduce the transmission of heat from the environment into the building or housing.

The window element including a window frame further has to prevent the window frame from establishing a thermal bridge and also, as far as the window frame is concerned, has to prevent the window frame from being deteriorated or destroyed through the exposure to heat, rain and moisture under varying weather conditions.

In addition, the window element of a modern building has to comply with aesthetic requirements and also functional requirements in terms of an attractive appearance allowing the window element to be easily incorporated into and allowing the architect to design the building without being limited by the design and the structure of the window element, and at the same time, from a functional point of view, should be easy to operate provided the window is openable and easy to maintain in terms of cleaning and service in case e.g. a broken window pane need to be substituted by a novel window pane.

An object of the present invention is to provide a window element composed of a minimum number of components and allowing the window pane itself to serve as an openable window without any casements circumferentially enclosing the window pane.

A feature of the present invention is to provide a window element made from a minimum number of components which may be integrated into the facade of a building or housing allowing the window elements to cover the facade of the building and at the same time allows a specific window to be constructed as an openable window or alternatively a permanently closed window without influencing to any substantial extent the appearance of the window element in question.

A particular advantage of the present invention relates to the fact that the window element according to the present invention produced from a minimum number of components may be easily converted by the simple substitution of a few components integrated into the window element from an openable window into a permanently closed window and vice versa, and in the conversion from an openable window to a permanently closed window or vice versa allows the building or housing to be configurated or modified in accordance with specific and altering use or requirements.

The above object, the above feature, the above advantage together with numerous other features and advantages which will be evident from the below detailed description of a presently preferred embodiment of a window element are according to a first aspect of the present invention obtained by a window element comprising:
a first glass panel constituting an outer window pane of an overall rectangular configuration defining a first set of parallel sides and a second set of parallel sides,
a second glass panel constituting an inner window pane of an overall rectangular configuration substantially co-extensive with the first glass panel, the second glass panel defining an inner window face,
a first and a second set of pultruded elements extending along the first and second set of parallel sides, respectively, and adhered to the first and second glass panels for interconnecting the first and second glass panels in a glazed window structure,
a window frame made of profiled pultruded elements circumferentially encircling the glazed window structure,
a set of co-operating hinged parts comprising a first part and a second part, the first part being adhered to the window structure at a first edge parallel with one of the sides of the first set of sides, the second part being integrated into or constituted by one of the profiled pultruded elements of the window frame, and
a set of closure elements adhered to the inner window face of the second glass panel at a second edge parallel with another side of the first set of sides and co-operating with recesses provided in an adjacent profiled pultruded element of the window frame for arresting the window structure in a closed and sealed state.

The window element according to the first aspect of the present invention includes only a minimum number of components, viz. the two glass panels which are joined together by means of a set of edgewise interconnecting pultruded elements serving as distance elements and also as high thermal insulating joints between the two glass panels.

Obviously, the window element according to the present invention may be modified by the provision of an additional glass panel providing a three layer glazed window structure or even more than three glass panels provided specific requirements relating to thermal insulating property or acoustic insulating property necessitate the provision of more than two glass panels or glazed window structures.

According to a particular advantageous embodiment of the window element according to a first aspect of the present invention, the first part of the set of co-operating hinged parts are adhered to the first glass panel and/or the second glass panel of the glazed window structure by means of an adhesive applied in a silk-screen printing process or application.

By the use of a silk-screen printing process or application, the adhesive joined between the first and/or second glass panel of the glazed window structure and the first part of the set of co-operating hinged parts may provide a transparent, or alternatively a non-transparent, joint dependent on the pigments included within the silk-screen printing adhesive. In addition, the first glass panel and/or the second glass panel may be constituted by a translucent, and non-translucent, a transparent, or non-transparent, or alternatively a painted or coated glass panel dependent on the specific application and/or the location, in particular the geographical location on which the window element is to be used and dependent on the climate, in particular the sun impact.

The use or adhesive applied in a silk-screen printing process or application provides the further important advantage that the extremely tightly compacted application of the adhesive provides a mechanical circumferential sealing preventing parts of the glass panel to which the adhesive is supplied in the silk-screen printing process from being separated from the adjoined first part of the set of co-operating hinges provided the glass panel in question is broken, and further provides a circumferential joint which keeps the glass panel together provided the panel is broken. From a safety point of view, the use of the silk-screen printing process for applying the adhesive is considered to be of extremely high importance.

It is to be realised that the window element according to a first aspect of the present invention may constitute a prefabricated element delivered from the factory or in the alternative. The glazed window structure may constitute a single component or element to be assembled with the co-operating hinged parts, the window frame and the closure elements at the site or location where the window element is to be mounted and used.

It is further to be realised that one of the glazed panels may be substituted by a polymer panel such as a transparent, translucent or alternatively non-transparent or non-translucent acrylic or polycarbonate polymer panel, in particular dependent on the application of the window element, i.e. the location and use, the size and the geographical location, etc.

According to the teachings of the present invention according to the first aspect of the present invention, the glazed window structure and in particular the glass panel or the glass panels is or are adhered to the first part of the set of co-operating hinged parts serve as a structural element as distinct from conventional glazed window structures which are to be circumferentially supported and encased within a reinforcing frame which is joined through respective hinges, etc. to the window frame. The glazed window structure as such serves as is well known in the art for insulating purposes, i.e. in particular thermo-insulating, but also acoustic insulating purposes.

In addition to the integrally joined glass panels the window frame serves to circumferentially encircle the glazed window structure and sealing off the glazed window structure without the necessity of providing a window casement in which the glazed window structure is encased for sealing against the window frame.

In the window element according to the present invention a set of hinges parts are provided interconnecting the glazed window structure and the window frame as the hinged part connected to the glazed window structure is simply adhered to the glazed window structure at the top or side edge thereof for providing a top-hinges or side-hinged window structure, respectively, as the first part of the set of co-operating hinged parts is preferably adhered to the pultruded element at the top or side of the glazed window structure in question.

Provided the window element according to the present invention constitutes a permanently closed and sealed window element, the closure elements which are simply adhered to the inner surface of the second glass panel are permanently arrested in the recesses of the adjacent profiled pultruded element of the window frame for permanently closing the window element.

Provided the window element is to be opened and constitutes a openable window, the set of closure elements are simply implemented as a set of closure elements having a handle serving to engage or alternatively disengage the closure elements from co-operating with the respective recesses for allowing the window structure to be opened.

The provision of the set of closure elements adhered to the inner side of the second glass panel of the glazed window structure on the one hand provides a highly attractive aesthetic appearance as the set of closure elements may be implemented as fairly small closure elements which irrespective of whether or not the closure elements are operable in an openable window element structure or are permanently closing and sealing off the window structure have the same overall appearance from the inside and also from the outside of the building.

Consequently, the overall appearance of the window element is independent of whether or not the window element is an openable window element or a permanently closed and sealed window element, and in addition, the window element may easily be modified by the substitution of the set of closure elements from a set of permanently closing off closure elements to a set of closure elements having an operable handle or vice versa for converting the window element from a permanently sealed off or closed window element into an openable window element or vice versa.

The first and the second glass panels of the glazed window structure of the window element according to the first aspect of the present invention may be of identical size providing outer parallel hedges or alternatively, the second glass panel may be larger or smaller than the first glass panel.

According to the presently preferred and highly advantageous embodiment of the window element according to the present invention, the first glass panel extends beyond the first and the second set of pultruded elements and seals against an outer circumferentially rim of the window frame. In the above highly advantageous and preferred embodiment of the window element according to the present invention, the window element may be positioned juxtaposed another window element allowing the first glass panel to provide an almost integral and unbroken outer glass panel face allowing an easy cleaning of the outer window facade and also provides a highly advantageous appearance.

According to the technique described in applicant's above-mentioned international patent application, the first and second set of pultruded elements are preferably made from glass fibres for providing pultruded elements integrally joining the first and second glass panels exhibiting a coefficient of thermal expansion similar to the coefficient of thermal expansion of the glass panels.

The circumferentially encircling window frame may be made from glass fibres, carbon fibres, kevlar fibres, natural fibres or combinations thereof, and being joined by means of an epoxy, PU, or thermosetting- or hardening adhesive, optionally including fire retarding additives, for fulfilling the coefficient of thermal expansion and also mechanical strength and stability.

The pultruded elements which according to the pultrusion technique itself may be made from various polymer materials including polyesters and epoxy may be adhered to the glass panels by means of PU adhesive or preferably epoxy adhesive.

For providing a gas tight inner space defined between the first and second glass panels, a gas tight foil such as an aluminium foil or stainless foil is preferably provided as a gas tight sealing of the first and second set of pultruded elements.

According to a particular advantageous feature of the window element according to the first aspect of the present invention, the glazed window structure is sealed off relative to the window frame by means of a sealing gasket providing a sealing off effect relative to an exterior overpressure and also an exterior underpressure. The sealing gasket is, as will be described below, configurated as a symmetrical structure providing the effect of sealing off irrespective of the orientation of the pressured gradient from the exterior to the interior through the window irrespective of any pressure variations as is often caused by winds generating a wind pressure or causing a higher exterior pressure as compared to the interior behind the window element or in the alternative providing a suction effect causing an exterior lower pressure as compared to the pressure prevailing within the interior space behind the window element.

As mentioned above, the window element according to the first aspect of the present invention may be implemented as a top-hinged or a side-hinged window element and, consequently, the first edge may constitute the top edge of the window structure providing a top-hinged window or alternatively, the first edge constitutes a side edge of the window structure providing a side-hinged window.

The above object, the above feature, the above advantage together with numerous other features and advantages which will be evident from the below detailed description of a presently preferred embodiment of a window element are according to a second aspect of the present invention obtained by a profiled pultruded panel to be used as a wall covering, preferably an outer wall covering, of a building or a house, the panel comprising:
an elongated, planar plate defining opposite first and second sides and a top and a bottom edge,
a set of profiled top and bottom flanges extending perpendicularly from the plate at the first side thereof along the top and bottom edges, respectively, the profiled top flange defining a top surface and the profile bottom flange defining a bottom surface complementary to the top surface of the top flange,
at least one further flange extending from the plate at the first side thereof from a position between the top and bottom flanges and defining an acute angle, preferably an angle of 45°, relative to the plate and sloping downwardly towards the bottom edge, and
the planar elongated plate, the set of profiled top and bottom flanges and the at least one further flange being integrally produced in a pultrusion process.

The profiled pultruded panel according to the second aspect of the present invention constitutes a weather resistant facing panel which may easily be mounted and joined to similar panels by interconnecting the top and bottom flanges of the profiled pultruded panels which are positioned on top of one another.

In addition, the profiled pultruded panel according to the second aspect of the present invention is positioned and fixated relative to a supporting surface such as a supporting building structure made from e.g. concrete, steel, wood or any other building material as the further flange defining an acute angle relative to the first side of the elongated planar plate is caused to grip behind a fixation device which has previously been fixated to the supporting building structure.

As distinct from conventional profiled pultruded panels or panels which are conventionally made from a planar plate having a plurality of perpendicularly pending webs, the further flange characteristic of the profiled pultruded panel according to the second aspect of the present invention extends in an acute angle, preferably in an angle of approximately 45° relative to the first side of the plate or to the inner side of the plate providing a flange which itself catches behind the fixation device and provides a self-locking of the panel relative to the supporting building structure due to the sloping configuration of the further flange.

In order to improve the fixation of the profiled pultruded panel according to the second aspect of the present invention to the supporting building structure, additional sloping flanges may advantageously be provided for providing several fixation and arresting flanges co-operating with corresponding fixation devices fixated to the supporting structure.

In order to improve the fixation of the profiled pultruded panel according to the second aspect of the present invention, the further flanges preferably have at their outer ends a downwardly protruding lip and have at their lower surfaces facing towards the bottom flange an inner recess complementary to the downwardly protruding lip.

The provision of the sloping flanges exhibiting the downwardly protruding lip and the inner recess which is complementary to the downwardly protruding lip allows the profiled pultruded panel to be used in combination with a fixation device which is simply produced by cutting off a part such as a web having a width of e.g. 5-20 cm of the profiled pultruded panel itself and turning upside down the web for providing the fixation device to be mounted and fixated to the supporting building structure.

As the fixation device is produced by a part of the profiled pultruded panel itself, the registration of the fixation devices provided a plurality of panels are positioned above one another is easily obtained by simply positioning the individual fixation devices on top of another by using the complementary configurated surfaces of the top and bottom flanges for properly positioning the fixation devices. In this context it is to be understood that the top flange of the profiled pultruded panel and the bottom flange of the profiled pultruded panel constitute in the inverted positioning of the fixation device cut from the profiled pultruded panel a bottom flange and a top flange, respectively.

The profiled pultruded panel according to the second aspect of the present invention further allows the panel to be configurated to integrally include fixtures for e.g. fixating electrical cables or wires, heating or water tubes and/or insulating panels or alternatively, a specifically configurated web into the profiled pultruded panel as the web may be integrated into the profiled pultruded panel in the pultrusion process itself.

The pultrusion process itself also allows the integration of differently configurated elements or components such as e.g. reservoirs extending longitudinally along the profiled pultruded panel which reservoirs may serve for dispensing e.g. a constituent for preventing the growth of micro organisms at the first side of the plate.

Although the configuration of the fixation flange or flanges provided by the downwardly sloping flanges of the profiled pultruded panel characteristic of the present invention prevents water from being accumulated within the inner space defined between the first side of the elongated planar plate and the supporting building structure, humidity may condense at the inner surface of the planar plate of the profiled pultruded panel and for preventing any micro organism such as algae to develop and cause a colouring of the profiled pultruded panel which may be at least partly translucent, reservoirs for the dispensing of micro organisms at the inner surface may be provided. According to a variant of the profiled pultruded panel having an integral micro organism growth preventing component, a copper conductor is simply integrated into the inner surface of the planar plate of the profiled pultruded panel which copper conductor dispenses copper irons which are contemplated to be capable of preventing any growth of micro organisms at the inner surface of the profiled pultruded panel constituted by the first side of the elongated planar plate.

The profiled pultruded panel itself may as stated above be translucent or be pigmented in order to provide a coloured profiled pultruded element. Alternatively, the panel may simply be painted and in this context e.g. a UV resistant paint or coating may advantageously be used. In addition, e.g. fire retarding coatings or paints may be used.

The present invention further relates to a system of a profiled pultruded panel according to the second aspect of the present invention and one or more fixation elements which one or more fixation elements are preferably and advantageously constituted by segments of the profiled pultruded panel being turned upside-down as discussed above.

The present invention further relates to a covering of a building or house which covering is constituted by a plurality of profiled pultruded panels according to the second aspect of the present invention and fixated in the system according to the present invention.

The present invention further relates to a building or housing having an outer covering constituted by a plurality of profiled pultruded panels, preferably implemented in accordance with the second aspect of the present invention and preferably fixated in the system according to the present invention.

Furthermore, the present invention relates to a method of providing an outer weather resistant covering of a building or a housing by use of the profiled pultruded panels according to the second aspect of the present invention.

Still further, the present invention relates generally to the technical field of building elements and in particular to building elements usable as solar panels, wall panels such as heating panels or panels in air conditioning systems.

Within the technical field of building elements, prior art patent applications describing building elements to be included in the building of a house or office building are known. The publications include WO 86/05224, WO 95/23270, WO 99/23344, WO 00/05474, WO 01/25581, WO 02/096623, U.S. Pat. No. 4,994,309, U.S. Pat. No. 5,727,356, U.S. Pat. No. 6,401,428, US 2002/0069600, US 2003/0037493, U.S. Pat. No. 6,591,557 and EP 0 328 823.

Building elements comprising pultruded elements have also been described previously in publications such as WO 91/19863 and WO 00/45003.

The applicant company is a world-wide leading manufacturer of pultruded structures and has delivered pultruded profiled elements for the building of e.g. bridges and also houses such as the Fiberline Bridge located in Kolding in Denmark and the Eye Catcher building built in Zurich in Switzerland. The advantageous properties of pultruded structural elements as to bearing capability, strength, low weight and further thermal insulating properties is well documented within the industry, e.g. in the manuals delivered by the manufacturers of profiled pultruded elements and in particular by the applicant company including the online design manual available from the applicant company.

It is an object of the present invention is to provide a novel technique of heating buildings by means of a novel building elements, which are made from high strength and lightweight elements, in particular of pultruded elements.

It is an object of the present invention is to provide a novel technique of providing cooling or air-conditioning to buildings by means of a novel building element.

The basis for the present invention is the realisation that pultruded elements provided a specific content of fibre material and a specific selection of fibre material be made may be combined with high-strength hardened glass panels for providing high-strength and highly stable building elements which may stand exposure to temperature variation without giving origin to excessive stresses in the joints in the building elements.

It is an advantage of the present invention that the novel building elements and the novel technique of assembling various form or heating elements from a combination of profiled pultruded elements renders it possible to on the site to assemble a number of elements to dedicate them to either provide heat, cooling into a building and/or to use the assembled building elements as a solar heating panel.

It is a further advantage of the present invention that the novel building elements may be combined to any rectangular shaped plane, which make them in particular suitable to fit into a building for heating purposes and to fit onto a building—e.g. on the roof or as a part of the roof-construction—for proving heat from incoming sunlight.

It is a particular aspect that the holes which are integrally to the novel building elements may be used for a various number of purposes, such as to transport a fluid, e.g. hot water for the purpose of heating a house, alternatively the fluid may be fluid heated from incoming sun light, allowing the same element or elements to be used as the main part in a solar energy installation.

It is another particular aspect of the present invention that the channels constituted by through-going holes may be used for various other purposes, such as the transport of a cooled fluid, e.g. cold water for the purpose of cooling down a house, alternatively the fluid may be fluid used to cool a solar cell whereby the effective lifetime of the electronics, e.g. silicon and the circuitry of sun cells, is extended.

It is a further aspect that the channels or holes of the building element can be used for purposes in combination with the above mentioned fluid transport purposes, e.g. to accommodate wires, cable, pipes, etc. whereby these are easily hidden within the building element and easily distributed in a building made by means of or including the novel building elements. As an example some of the channels constituted by through-going holes may be used for transporting fluids (air, water, liquid, etc) whereas other channels may be applied to accommodate wires, cable, pipes to provide telecommunication, computer-communication, hydraulic controlled pressure, vacuum, etc to buildings, houses, apartments, etc constructed by means of the building elements according to the present invention.

The above object and the above advantage together with numerous other objects, advantages and features which will be evident from the below detailed description of the present invention is according to the present invention obtained by a building element comprising:
a profiled panel defining a major surface of an overall rectangular configuration and defining parallel opposite first and second ends and parallel opposite third and fourth ends,
a profiled channel housing defining a first set of opposite first and second sides juxtaposed the first and second ends of the profiled panel and the profiled channel housing defining a second set of opposite third and fourth sides juxtaposed the third and fourth ends of the profiled panel,
the building element having at the first and second side and or/ends a respective first and second profiled connector, each of the first and second connectors extending between the third and fourth parallel sides and/or ends, the first and second connectors being matingly configured for allowing the first connector for an overlapping, resting and catching joining with another co-operating second connector of a matching shape of a second identical and adjacent building element, and allowing the second connector for a resting and catching joining with another co-operating overlapping first connector of a matching shape of a third identical and adjacent building element, and
the profiled channel housing comprising a number of identical and adjacent through-going channels, each of the channels extending between the first and second parallel ends and/or between said the third and fourth parallel ends, the through-going channels alone or in combination with the profiled panel defining an identical number of through-going holes.

According to a first embodiment of the building element according to the present invention, the profiled panel is integrally pultruded with the profiled channel housing. Hereby these two parts are provided from a single pultruding process.

According to a second embodiment of the building element according to the present invention, the profiled panel and the profiled channel housing are separately pultruded prior to assembly of the building element. Hereby these two parts are provided from two individual respective pultruding processes.

According to the teachings of the present invention, the first and second profiled connector may be integrally pultruded with the profiled panel. Hereby these three parts are provided from a single pultruding process.

According to the teachings of the present invention, the first and second profiled connector may be integrally pultruded with the profiled channel housing. Hereby these three parts are provided from a single pultruding process.

According to the teachings of the present invention, the first and second profiled connectors may be integrally pultruded with the profiled channel housing and the profiled panel. Hereby these four parts are provided from a single pultruding process.

According to the teachings of the present invention, the number of holes being fluid tight, accordingly the holes or channels may be applied to transport and/or provide a fluid such as hot or cold water, air, oil, etc.

According to the teachings of the present invention, the number of holes are preferably mutually equidistantly spaced from the first side and the second side and/or ends or from the third and fourth side and/or ends of the building element. Hereby two building elements can be joined together regardless of their orientations, while ensuring that the two sets of holes are aligned to one another.

According to the teachings of the present invention, the holes define a first and a second end, and the hole having an inlet connection being provided at the first end and an outlet connection being provided at the second end. Hereby pipes, piping and/or other tubular elements may be connected in fluid communication to the holes of the building element or of the profiled channel housing.

According to the teachings of the present invention the building element may be a heating panel, e.g. with thermostat control of the fluid provided through means of the holes.

Alternatively, according to the teachings of the present invention the building element may constitute a solar cell panel constituting the building element which is provided with one or more solar cells on top of its major surface and optionally further covered by a translucent and/or transparent layer, preferably constituted by a pultruded covering.

According to the teachings of the present invention, the building element being a solar cell panel may constitute the building element having a layer of glass on top of its major surface.

According to the teachings of the present invention, the first connector of the building element may have a bigger size than that of the second connector. However, the connectors are preferably of an identical size and shape.

According to the teachings of the present invention, the number of holes of the building element or the profiled channel housing may be 2-10, such as 4-6 or 5, alternatively 2-4, 4-6, 6-8 or 8-10.

According to the teachings of the present invention the holes may be used for transporting heated fluids, e.g. hot air, hot water or sun panel fluids, whereby the building element may be applied to heat the interior of a home or be applied to retrieve energy from the sun by means of a sun heated fluid running in and through the holes, e.g. for the latter case when the building element is applied on top of a roof or as roof element.

Alternatively or additionally, the holes may be for transporting cold or cooled fluids, e.g. cold air or cold water, whereby the building elements may be applied to cool down a home or be applied as an air-conditioning element in addition to or as an alternative to the purpose of providing heat by means of the heated fluid.

The cold fluids may be applied to cool solar cells to extend their lifetime.

According to the teachings of the present invention, the building element may have its major surface made of a transparent material and/or of a translucent material.

According to the teachings of the present invention, the building element may have its major surface provided with a layer of transparent polyester.

According to the teachings of the present invention the building element may have its major surface joined to a layer of a thermal insulating material. Hereby, when the element is applied in a roof structure of a building, the waste or loss of energy from the building covered by the building element is minimised.

According to the teachings of the present invention, the building element may have, on top or below its major surface, a layer of a thermal insulating material, alternatively the thermal insulating material may be integral to the building element.

According to the teachings of the present invention, the building element may have on top or below its major surface a layer of black polyester, or a layer of dyed black polyester.

According to the teachings of the present invention the building element, either the profiled panel or the profiled channel housing or the profiled connectors may be provided through a pultrusion process.

Alternatively, the elements may be provided from an extruding process, i.e. the profiled panel, the profiled channel housing and the two profiled connectors all may be provided through extrusion.

Still further alternatively, the building element, either the profiled panel or the profiled channel housing or the profiled connectors may be provided through an extrusion process.

Alternatively and most preferably, all the elements may be provided as a result of a pultrusion process, i.e. the profiled panel, the profiled channel housing and the two profiled connectors all may be provided through the pultrusion process.

The profiled panel, the profiled channel housing or the profiled connectors may be provided through an extruding process. However it is the preferred choice of the applicant to provide some or all the elements according to the invention by means of a pultrusion process.

Within the technical field of pultrusion, a variety of different fibres have been used, in particular glass fibres, carbon fibres and kevlar fibres. In the present context, glass fibres are preferably used, however, in specific applications, additional or alternative fibres such as carbon fibres, kevlar fibres or natural fibres may be used in addition to or as an alternative to the glass fibres.

The above object and the above advantage together with numerous other objects, advantages and features which will be evident from the below detailed description of the present invention is according to the present invention obtained by a method of producing a fibre reinforced building element comprising the steps of:
i) providing through a pultrusion process a profiled panel defining a major surface of an overall rectangular configuration and defining parallel opposite first and second ends and parallel opposite third and fourth ends,
ii) providing through a pultrusion process a profiled channel housing defining a first set of opposite first and second sides juxtaposed the first and second ends of the profiled panel and the profiled channel housing defining a second set of opposite third and fourth sides juxtaposed the third and fourth ends of said profiled panel,
iii) covering either the major surface of the profiled panel or the profiled channel housing with reinforcing fibres and resin, the resin have been applied in the pultruding of the profiled panel and/or in the pultruding of the profiled channel housing,
iv) positioning and aligning the two major surfaces of the profiled panel and the profiled channel housing onto one another with the reinforcing fibres and resin located between the two major surfaces, and
v) heating and curing the profiled panel and the profiled channel housing together so as to provide the fibre reinforced building element.

In an embodiment, the method further comprising the steps of
vi) applying reinforcing fibres and resin to parallel sides of the fibre reinforced building element, and
vii) heating and curing the first and the second profiled connector onto to respective two parallel sides of the fibre reinforced building element so as to provide the fibre reinforced building element with the first and the second profiled connector.

It is to be understood that the content of reinforcing fibres to some extent depend on the coefficient of thermal expansion of the solidified or hardened resin as a resin having a coefficient of thermal expansion highly different from the coefficient of thermal expansion of glass may necessitate the use of a higher content of reinforcing fibres. The resin used in according with the teachings of the present invention is preferably a polyester resin, however, as is well known within the art of pultrusion, also vinyl ester, phenols and epoxy resin may be used for the pultrusion process.

For most applications of the building elements, the building elements are of a rectangular configuration, however, the building elements as taught by the present invention are by no means limited to the geometrical configuration of a rectangular panel, as triangular panels, polygonal panels etc. may be manufactured in accordance with the teachings of the present invention.

In the present specification all terms such as ‘up’, ‘down’, ‘vertical’, ‘horizontal’, ‘front’, ‘rear’, ‘side’, ‘end’, ‘major surface’, etc. are to be construed in the context of the various intentional applications of the elements in question and by no means to be referred to as limiting definitions of orientations referring to e.g. the orientations of elements during the process of use and to the assembly of elements.

According to a fourth aspect of the present invention, a method of producing a fibre reinforced building element is provided comprising the following steps:
i) providing the profiled panel and the profiled channel housing for their joining, both provided from the pultrusion processes,

Now these two in before pultruded parts are ready to be joined in the next steps:
ii) covering either the major surface of the profiled panel or the profiled channel housing with reinforcing fibres and resin, for example the resin which has already been used in the pultruding processes for providing either the profiled panel and/or the profiled channel housing, hereby it is secured that the resin is compatible with these two parts to be joined,
iii) now the two major surfaces of the profiled panel and the profiled channel housing are positioned and aligned onto one another with the reinforcing fibres and the resin being located between the two major surfaces, and finally,
iv) the profiled panel and the profiled channel housing are heated and cured together so as to provide the fibre reinforced building element.

When the two major surfaces of the profiled panel and the profiled channel housing are aligned onto one another, then e.g. the open longitudinal part of any channel of the profiled channel housing facing the profiled panel will be covered and closed by the major surface of the profiled panel, whereby such channel defines a through-going hole.

Moreover the following two steps may be added:
v) reinforcing fibres and resin are applied on one of the two sets of parallel sides of the fibre reinforced building element, and finally:
vi) a first and a second profiled connector are heated and cured onto respective parallel sides of the fibre reinforced building element so as to provide the fibre reinforced building element.

The invention is now to be further described with reference to the drawings in which

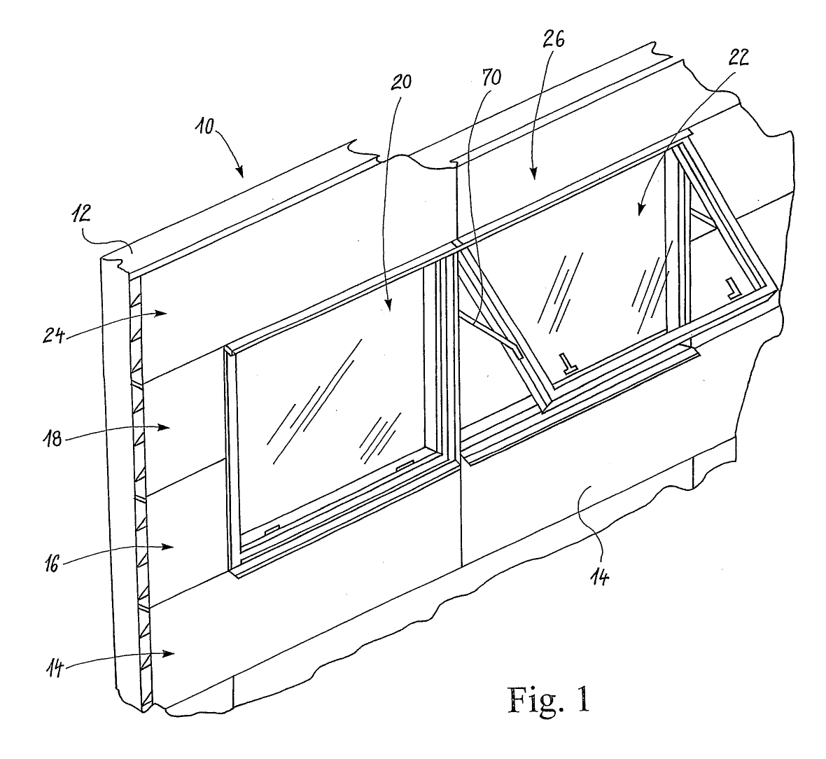

FIG. 1 is an overall and schematic view of a facade implemented in accordance with the teachings of the present invention by the use of a number of profiled pultruded panels according to the present invention and also including two window elements implemented in accordance with the teachings of the present invention,

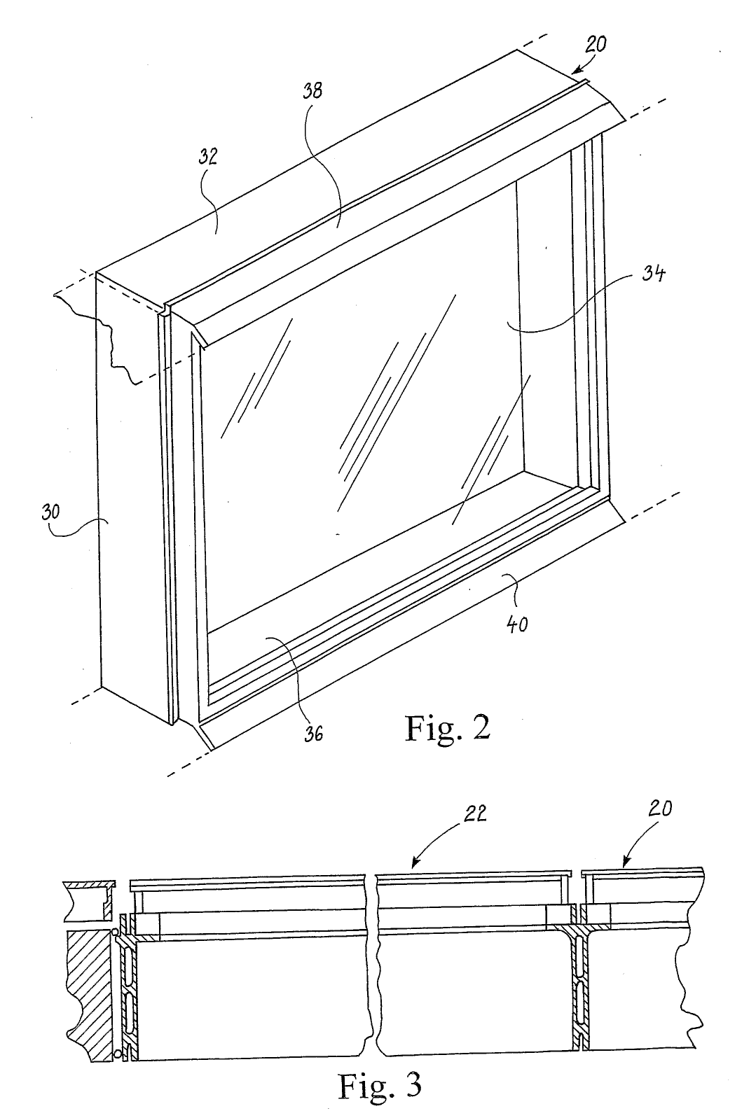

FIG. 2 is a perspective view of the window element according to the present invention,

FIG. 3 is a top sectional view of the window element also shown in FIG. 2,

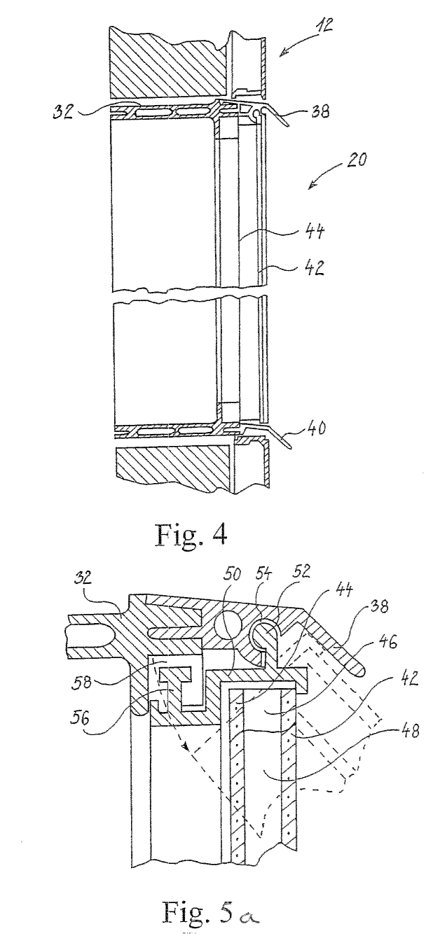

FIG. 4 is a vertical sectional view of the window element also shown in FIGS. 2 and 3,

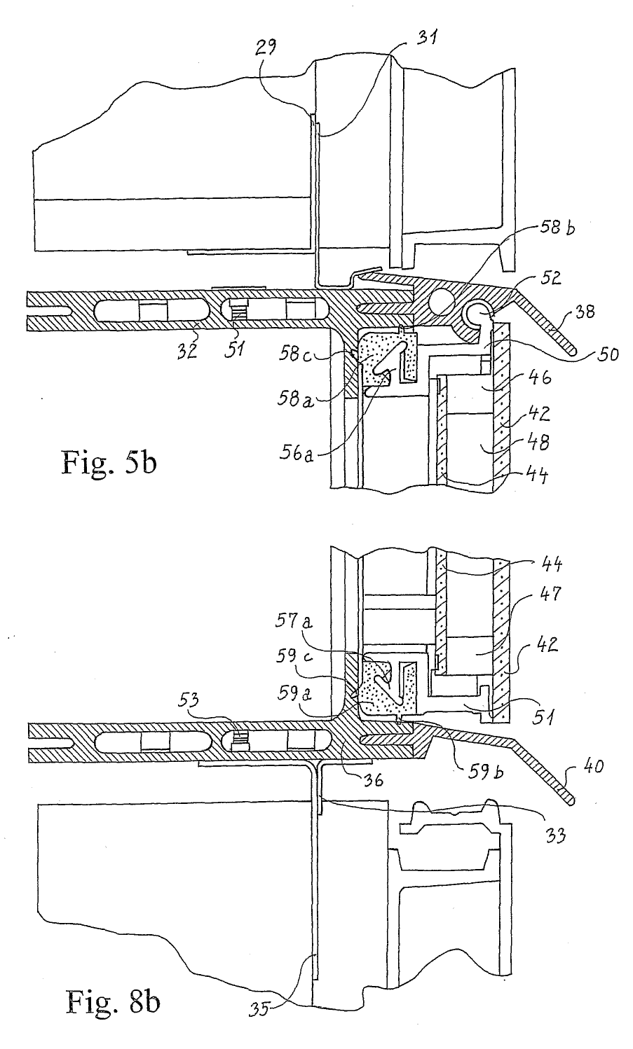

FIG. 5a is a vertical sectional view of a detail of the top hinge of the window element also shown in FIGS. 2-4,

FIG. 5b is a view similar to the view of FIG. 5a illustrating a detail of a variant of the top hinge of the window element also shown in FIGS. 2-4.

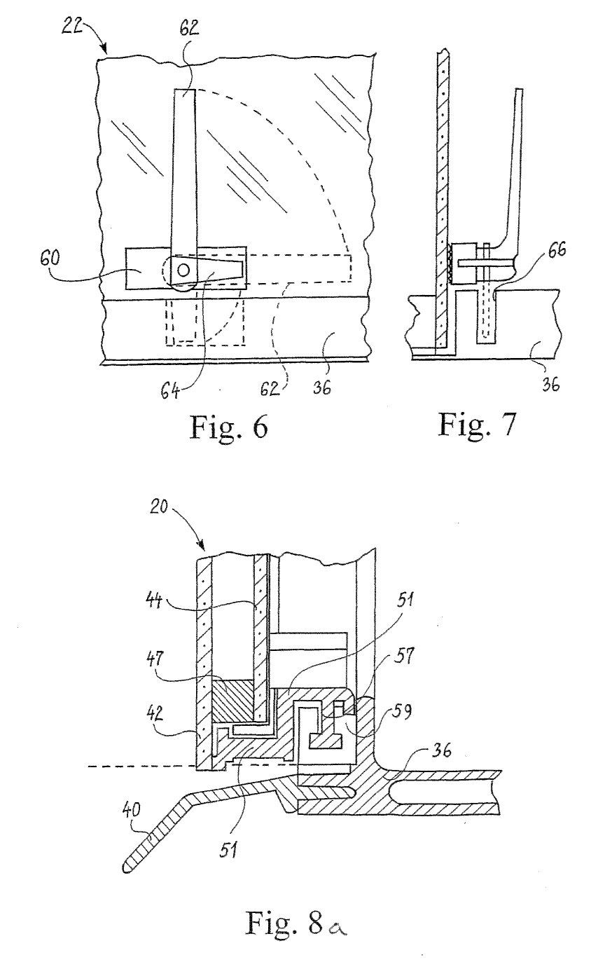

FIGS. 6 and 7 are views illustrating details of a closure of the window element shown in FIGS. 2-5,

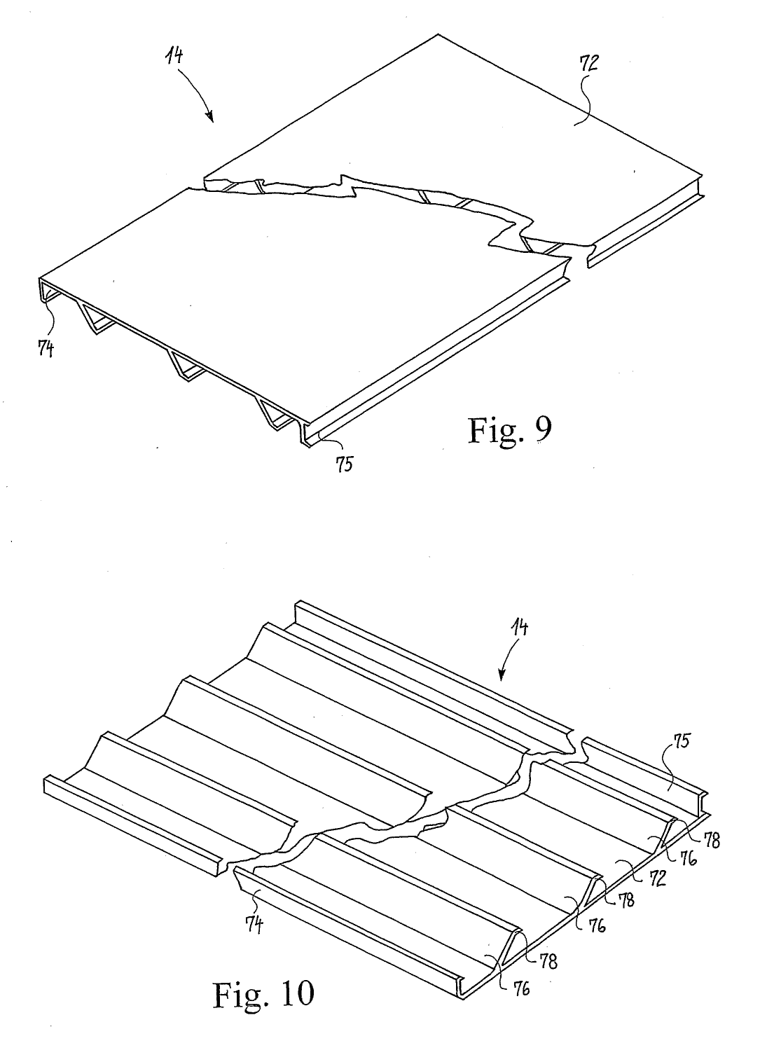

FIG. 8a is a vertical sectional view illustrating a detail of a bottom part of the window element shown in FIGS. 2-7,

FIG. 8b is a view similar to the view of FIG. 8b illustrating a detail of a variant of the bottom part of the window element shown in FIGS. 2-4, 6 and 7.

FIG. 9 is a top, perspective and schematic view of a presently preferred embodiment of a profiled pultruded panel according to the present invention to be used as a building covering panel,

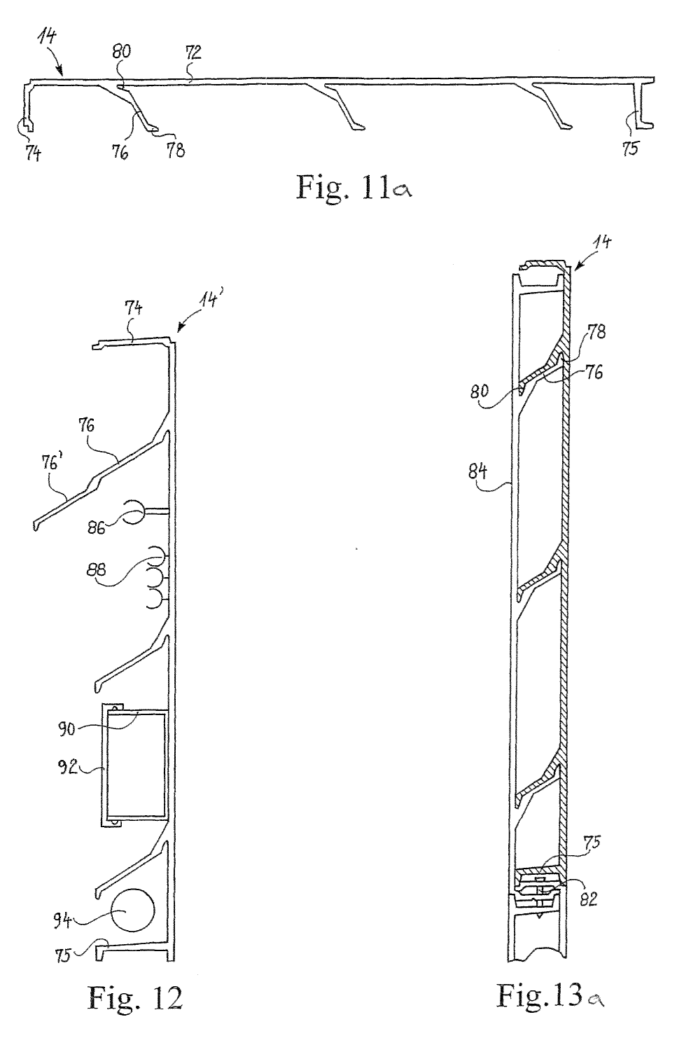

FIG. 10 is a bottom perspective and schematic view of the profiled pultruded panel also shown in FIG. 9,

FIG. 11a is a vertical sectional view of the profiled pultruded panel shown in FIGS. 9 and 10,

FIG. 11b is a vertical sectional view similar to the view of FIG. 11a of an alternative configuration of the profiled pultruded panel,

FIG. 12 is a vertical sectional view of a variant of the profiled pultruded panel according to the present invention,

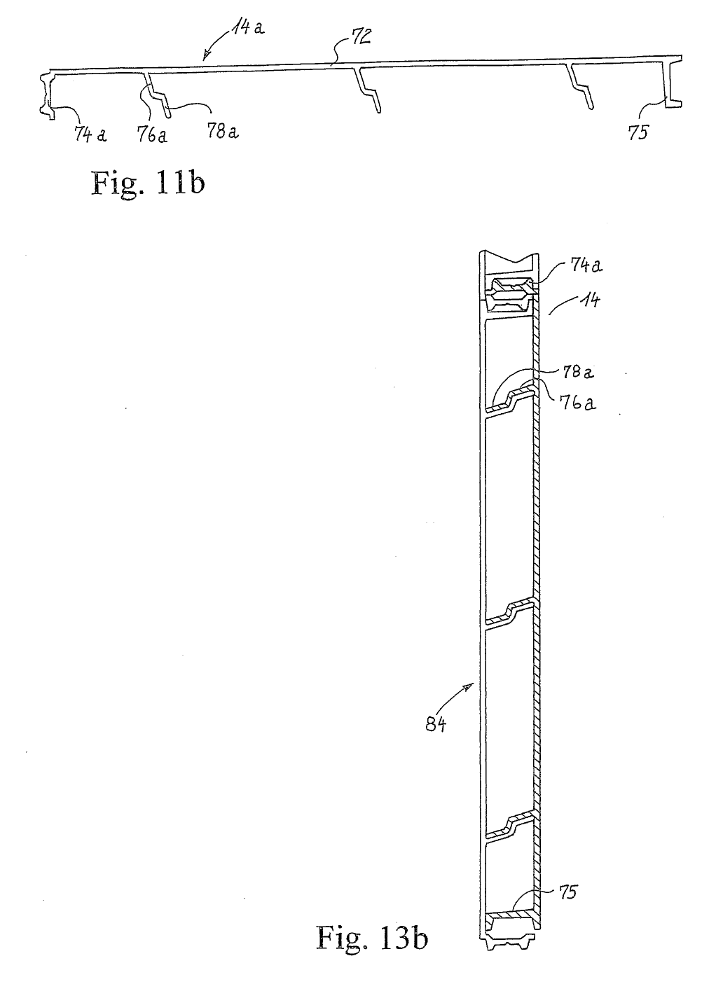

FIG. 13a is a vertical sectional view illustrating the technique of using a segment of the profiled pultruded panel shown in FIGS. 9-11 as a fixation device for fixating the profiled pultruded panel shown in FIGS. 9-11 to an outer wall of a building or a house,

FIG. 13b is a view similar to the view of FIG. 13a illustrating the technique of using the profiled pultruded panel shown in FIG. 11b.

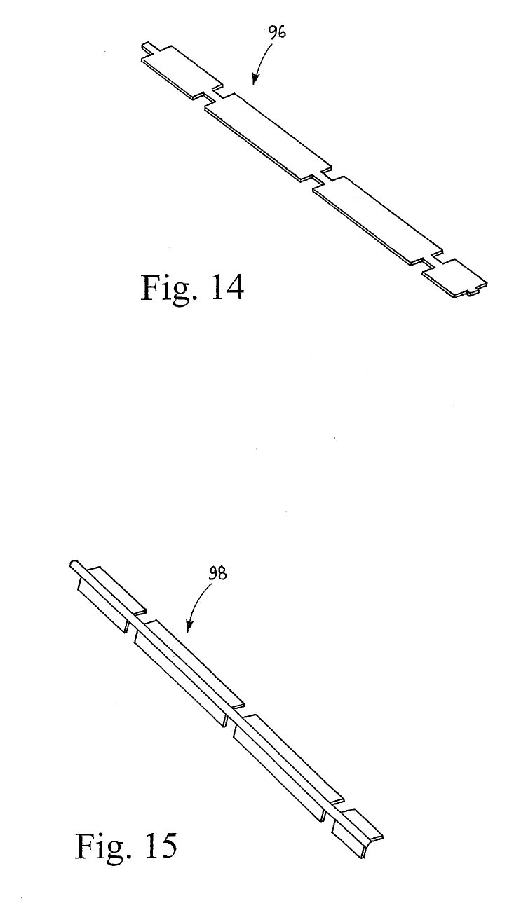

FIG. 14 is a perspective and schematic view of a plate element to be used for interconnecting two profiled pultruded panels to be adjoined edgewise to one another,

FIG. 15 is a perspective and schematic view similar to the view of FIG. 14 of a joining element to be used for joining two profiled pultruded panels along a corner of a building structure,

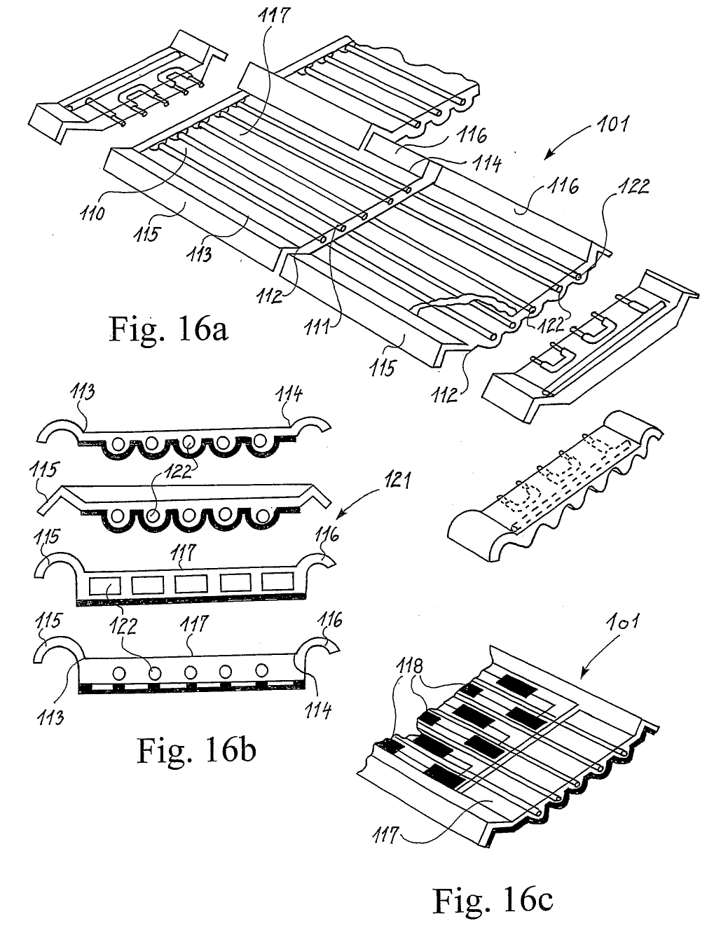

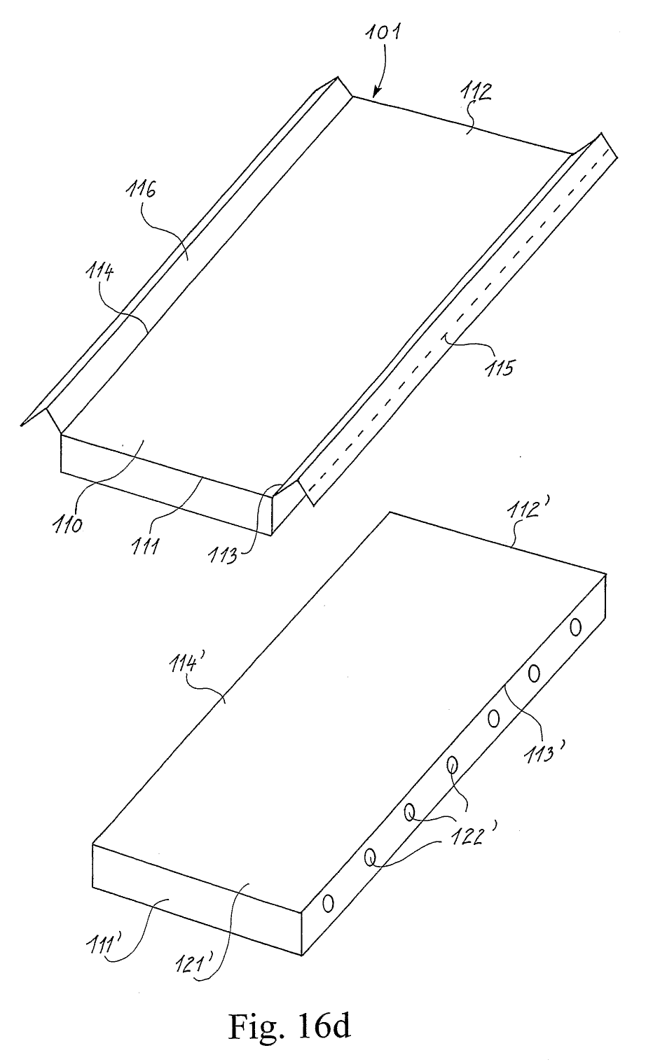

FIG. 16a is a perspective, partly sectional and exploded view of a building element to be used as a roof or ceiling element,

FIG. 16b is a vertical sectional view of variants of the building element shown in FIG. 16a,

FIG. 16c is a sectional and perspective view of a variant of the building element shown in FIG. 16a,

FIG. 16d is a perspective and exploded view of the building element according to the present invention,

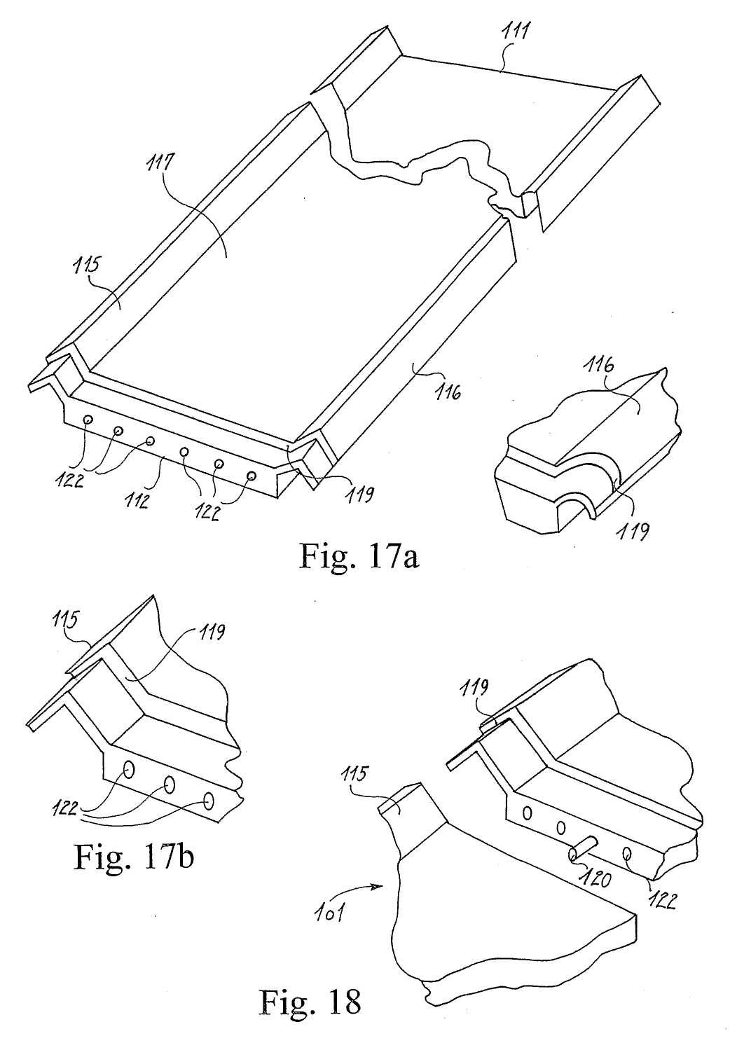

FIG. 17a is a sectional, perspective top view of a further embodiment of the building element according to the present invention,

FIG. 17b is a detail of the building element shown in FIG. 17a,

FIG. 18 is a perspective, partly broken away view illustrating the technique of assembling two building elements according to the present invention in a juxtaposed assembling process,

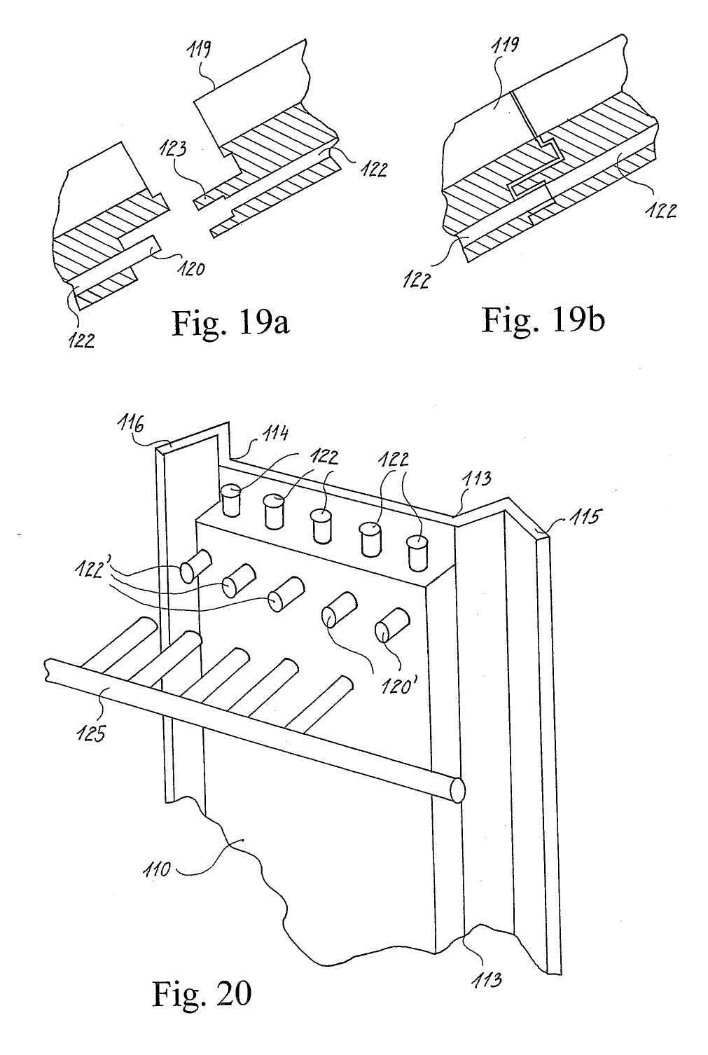

FIGS. 19a and 19b are vertical sectional views illustrating two building element s prior to and after joining the building elements,

FIG. 20 is an elevational, perspective and partly cutaway view of a further embodiment of a building element according to the present invention to be used as a ceiling or roof element,

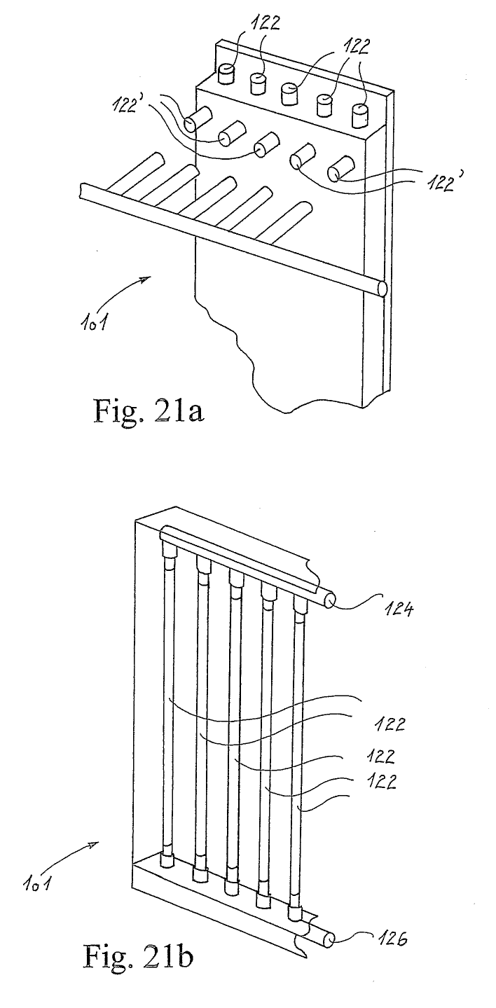

FIGS. 21a and 21b are elevational, perspective and partly cutaway views similar to the view of FIG. 20 of alternative variants of the building elements according to the present invention constituting wall elements to be used for the application of heat by means of a heated liquid such as heated water or heated, respectively, and

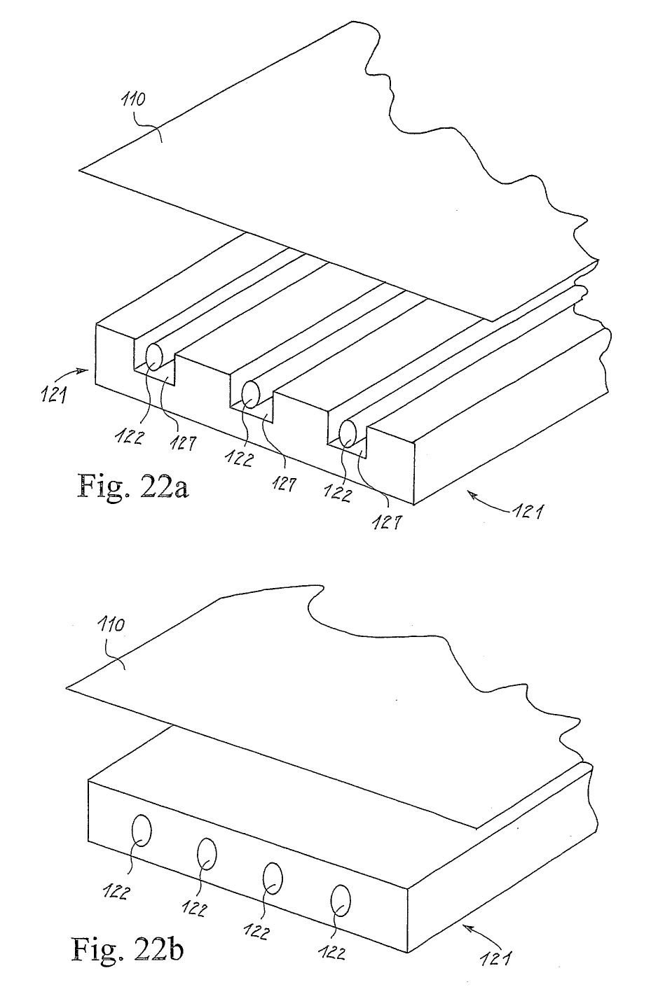

FIG. 22a and 22b are perspective, and partly sectional, views of components to be joined together for the assembling of the building element according to the present invention.

Throughout the drawings, the same reference numerals indicate identical elements or components. In the present specification, components or elements identical to components or elements, respectively, described previously with reference to a preceding figure are designated the same reference numerals and components or elements differing from previously described components or elements, respectively, however serving the same overall purpose, are designated the same integer as the previously described component or element.

In FIG. 1, an outer wall of a house or a building is shown which outer wall is designated the reference numeral 10 in its entirety. The wall is supported by a supporting structure 12 which may be made from concrete, steel, wood, pultruded elements or combinations of the above materials and which delimits the configuration of the outer wall and also includes e.g. insulating material and optional heating pipes, electrical installations including electrical power, computer wiring, etc. The supporting structure 12 may be made as a single layer or double or multi layer structure in which the individual layers are insulated relative to one another by means of an interlayer insulating material layer. On the outer surface of the supporting structure 12, a plurality of profiled pultruded panels are mounted and fixated in accordance with a technique which will be described in greater details below.

In FIG. 1, a total of six profiled pultruded panels are shown, two of which are designated the reference numeral 14 and constituting a bottom set of panels on top of which two panels 16 and 18 are positioned adjacent to two windows 20 and 22. Above the panel 18, a further profiled pultruded panel 24 is mounted bridging across the window 20 and on top of the window 22, a further profiled pultruded panel 26 is positioned and fixated.

The profiled pultruded panels are shown in greater details in FIGS. 9, 10, 11a, 11b, 12, 13a, and 13b and the window elements are shown in greater details in FIGS. 2, 3, 4, 5a, 5b, 6, 7, 8a and 8b to be discussed in greater details below.

The window elements 20 and 22 are constructed from identical elements, however, differing from one another in that the window element 20 is a permanently closed or sealed-off window, and the window element 22 is a openable window element as illustrated in FIG. 1. According to the teachings of the present invention, the window elements 20 and 22 will readily be modified as the permanently sealed window element 20 may readily be modified into an openable window, and similarly, the window element 22 may readily be converted into a permanently closed window element.

In FIG. 2, the window element 20 is shown in greater details. The window element 20 comprises a stationary circumferential rim composed of two side posts 30 and 34, a top post 32 and a bottom post 36. From the top post 32, an outwardly protruding element 38 extends providing a top drip cap. Similarly, a bottom drip cap 40 is provided at the bottom post 36. The window element 20 is, as is evident from FIGS. 4 and 5, composed of two glass panels 42 and 44 which are kept in space apart relationship by means of a set of circumferential distance elements 46 which seal off an inner space 48 defined between the two glass panels providing a glazed window structure.

The glazed window structure is at its upper edge adhered to a top hinge part 50 constituted by a pultruded element providing a circular cylindrical body part 52 which is received within a circular groove of the top drip cap 38. The top drip cap 38 constitutes an extension of a profiled pultruded element which is fixated in a wedged joint to the top post 32 of the frame of the window element. The profiled pultruded element 50 constituting the movable hinged part of the window element adhered to the glazed window structure is, as is evident from FIG. 5a, provided with an integral T-shaped flange 56 on which an insulating sealing body 58 is mounted. The insulating body 58 may be made from a high insulating rubber or elastomer material such as natural rubber or foamed plastics material. Similar to the insulating body 58, insulating bodies are provided extending along the sides of the glazed window and also along the bottom edge of the window element as is illustrated in greater details in FIG. 8a.

In FIG. 8a, the lower drip cap 40 is shown which is fixated to the bottom post 36 in a wedged joint similar to the joint between the top drip cap 38 and the top post 32.

In FIG. 8a, a pultruded element 47 is shown serving the same purpose as the above described distance element 46 shown in FIG. 5a. The bottom part of the window element 20 further discloses a bottom profiled pultruded element 51 similar to the above described element 50 and fixated to the bottom part of the glazed window structure in which the outer glass panel 42 extends beyond the distance element 47 as distinct from the top part shown in FIG. 5a in which the upper edges of the outer glass panel 42 and the inner glass panel 44 are positioned at identical heights. From the profiled pultruded element 51 joined and adhered to the glazed window structure including the glass panels 42 and 44, a downwardly protruding flange 57 similar to the above described flange 56 serves to fixate an insulating and sealing body 59 similar to the above described insulating and sealing body 58.

In FIGS. 5b and 8b, a variant of the window element 22 differing from the above described embodiment shown in FIGS. 5a and 8a in that the integral T-shaped flanges 56 and 57 are substituted by a differently configurated T-shaped flange 56a and 57a, respectively, having a sloping top of the T-shaped profile. In addition, the insulating body or sealing gaskets 58 and 59 shown in FIGS. 5a and 8a, respectively, are substituted by a differently configurated sealing gasket 58a and 59a shown in FIGS. 5b and 8b, respectively, basically configures so as to allow the sealing gasket to be mounted on the co-operating sloping profiled T-shaped flanges 56a and 57a and at the same time provide through-going sealing beads 58b, 58c and 59b, 59c sealing against the horizontal and the vertical surfaces of the window frame for providing a sealing off effect relative to overpressure and underpressure prevailing exterior relative to the inner space defined behind the window, which over- and underpressures are generated most often by wind pressure and wind suction, respectively. In FIGS. 5b and 8b, an additional set of profiled metal elements 29, 31 and 33, 35, respectively, are shown for fixating the profiled pultruded elements of the window structure. In addition, FIGS. 5b and 8b illustrate a threaded bar 51 and 53, respectively, serving to co-operate with threaded T-knots for joining the top and bottom profiled elements of the window structure together and maintaining the window structure in the intentional configuration.

In FIGS. 6 and 7, a detail of the closure elements of the window element 22 is shown. The closure element is constituted by a supporting body 60 which is adhered to the inner side of the glass panel 44 and further a handle 62 which is joined to a lath 64 which is shown in FIG. 6 in its raised position in which the window 22 may be opened as is illustrated in FIG. 1 as the lath 64 is raised freely above the bottom edge part of the bottom web 36. By turning the handle 62 clockwise to a position shown in the dotted line in FIG. 6, the lath 64 is caused to move into a recess 66 of the bottom post 36 for causing the window element to be closed and sealed. According to the basic teachings of the present invention, the handle operated locking and sealing lath 64 may be omitted in which case the lath 64 is permanently arrested in the recess 66 permanently closing and sealing off the window element. In this context, the use of a minimum of components and identical pultruded elements in both window elements 20 and 22 shown in FIG. 1 constituting a permanently closed and an openable window, respectively, allows even permanently closed or fixed windows to be made from the same components and include inherently the hinged parts of the openable window 22 without increasing the overall price of the window element by the presence of the unused hinged part.

Apart from the hinged parts described above with reference to FIG. 5a, additional arresting elements such as an arresting arm 70 shown in FIG. 1 may be provided allowing a continuous opening of the window, or alternatively allowing a stepwise opening of the window, and furthermore, conventionally known multi-positioning window elements may be provided for allowing the window element to be opened in different orientations and tilted.

In FIGS. 9 and 10, one of the profiled pultruded panels shown in FIG. 1 is illustrated in greater details. In FIG. 9, the profiled pultruded panel 14 is illustrated as viewed from the outside, and in FIG. 10, the profiled pultruded panel is illustrated as shown from the inner side facing the supporting building such as the supporting building 12 shown in FIG. 1. The panel 14 comprises a substantially planar plate 72 which may be non-transparent or at least partly translucent provided no substantial content of pigments be included in the polymer material from which the profiled pultruded panel is made.

At an upper edge of the plate 72, a top flange 74 extends perpendicularly from the inner side of the plate. Opposite to the top flange 74, i.e. at the bottom edge of the plate 72, a bottom flange 75 extends which has an outer configuration which is complementary to the configuration of the top flange 74 allowing the bottom flange 75 to fit with and lock into the top flange of another panel similar to the panel 14 shown in FIG. 9. From the inner side of the plate 72, a total of three additional flanges extend which are designated the reference numeral 76. The three flanges 76 are mutually parallel and extend at an angle of approximately 45° sloping towards the bottom flange 75 and has an outwardly protruding lip 78 which is shown in greater details in FIG. 11a.

Each of the sloping edges 76 is further at its innermost lower side provided with a recess 80 which is configurated so as to allow the recess to receive the outwardly protruding lip 78 of the profiled pultruded panel as is illustrated in FIG. 13a. According to the advantageous and preferred embodiment of the profiled pultruded panel 14 shown in FIGS. 9, 10 and 11a, each of the sloping flanges 76 are configurated so as to allow the lower surfaces of each of the flanges to co-operate and receive an inversely orientated flange of an identical same profiled pultruded element. This feature of allowing the identical element to be received provides an extremely simple fixation technique as the profiled pultruded panels shown in FIG. 1 are easily mounted in their intentional position by cutting off along an edge of the panels a segment such as a segment having a width of 10-20 cm, turning the segment upside-down and fixating the element to the supporting building by e.g. screws or nails or by means of an adhesive or a combination thereof and positioning additional segments on top of the previously mounted segment so as to provide a row of supporting segment serving as fixation devices for the panels to be fixated to the supporting wall.

In FIG. 13a, the fixation technique is illustrated as the right side cross-hatched profiled element 14 constitutes the panel whereas the unhatched left-hand side elements constitute the fixation segments to which the cross-hatched panel 14 is fixated. In addition to the arresting of the outwardly protruding lip 78 within the recess 80, the panels may be further fixated by means of a fixation screw 82. In FIG. 13a, the fixation device is constituted by a segment of the profiled pultruded panel d designated the reference numeral 84.

In FIG. 11d, an alternative and presently preferred embodiment of the profiled pultruded panel according to the present invention is shown designated the reference numeral 14a, differing from the above-described first embodiment shown in FIG. 11a in that the free sloping flanges similar to 76 shown in FIG. 11a are composed of two cranked parts 76 and 78 allowing the panel to be easily joined with the profiled element serving to fixate the panel as is shown in FIG. 13b, including the same signature as used in FIG. 13a. In addition, the embodiment 14a of the profiled pultruded panel differs from the above-described first embodiment in that the top flange is provided with elongated upwardly pultruding beads as is illustrated in FIG. 11b for providing an improved arresting of the adjoined panel as is illustrated in FIG. 13d as compared to the joining of the panel 14 with the lower panel as is shown in FIG. 13a.

The technique of providing the outer surface covering of a building as panels produced in an integral pultrusion process also allows the pultruded elements to be configurated so as to receive cables by integrally providing cable holding elements which are included in a variant of the profiled pultruded panel which variant is shown in FIG. 12 and designated the reference numeral 14′. In addition to the top and bottom flanges 74 and 75, respectively, and the downwardly sloping fixation flanges 76, a major cable holder 86 is provided together with a plurality of three minor cable or tubing fixation elements 88.

In FIG. 12, a further duct 90 having a cover 92 is shown in which duct e.g. low voltage cables such as telephone or computer cables may be mounted. In FIG. 12, the reference numeral 94 designates a water tube which may be housed within the inner space defined behind the profiled pultruded panel 14.

According to a further alternative or variant of the profiled pultruded panel 14, the sloping flanges 76 are elongated by adding a further extension of each of the flanges allowing the profiled pultruded panel to be positioned with a larger spacing to a supporting building as the extension of each of the flanges 76 may be cut off the supporting fixation element such as the element 84 shown in FIG. 13.

In FIG. 12, one extension of one of the flanges 76 is shown in phantom line and designated the reference numeral 76′.

For joining two adjacent panels together such as the panels 24, 26 shown in FIG. 1, a sealing and joining element is preferably used, which element is shown in FIG. 14 and designated the reference numeral 96. The element is simply introduced edgewise into one of the panels 24 or 26 and fixated in the recesses 80. Then the next panel is pushed into and joined with the element 96.

At the corners of the building, a similar bent-joining element may be used which element 98 is shown in FIG. 15.

The technique of assembling panels together by means of the elements 96 and 98 shown in FIGS. 14 and 15, respectively, will be modified by simply using a through-going connecting plate and cutting by means of a rotational cutter a groove edgewise into the adjacent panels to be joined together by means of the plate.

In FIG. 16a, a first embodiment of a building element according to a further aspect of the present invention is shown designated the reference numeral 101 in its entirety. The building element may constitute a profiled panel 110 defining a major surface 117 of an overall rectangular configuration. The rectangular configuration defines two sets of parallel opposite and second ends 113 and 114 and another set of parallel opposite third and fourth ends 111 and 112.

Additionally, the building 101 element is constituted by a profiled channel housing integral with the profiled panel 110.

The building element has at its first and second ends 113 and 114 a respective profiled first and second connector 115 and 116. Each of the connectors 115 and 116 extends between the parallel ends 111 and 112 and along the respective parallel ends 113 and 114.

The first connector 115 is configured so as to provide an overlapping, resting and catching joining with another co-operating second connector 116 of a corresponding shape of a second identical and adjacent building element, whereby the profiled panel and the second building element constitute one single big panel surface.

The second connector 116 is configured so as to provide a resting and catching joining with another co-operating overlapping first connector 115 of a corresponding shape of a third adjacent and identical building element, whereby the profiled panel and the third building element constitute one single big surface. As a result of the joining of the connectors 115 and 116 at both ends of the elements, three elements are connected together. Accordingly any desired shape and size of the resulting assembled, connected or joined elements as one single profiled panel may be provided.

The building element 101 may be comprised by a number of through-going channels 122. Each of the channels extends between the ends 111 and 112, or alternatively between the ends 113 and 114, not shown in FIG. 16a.

FIG. 16b shows four different variants of the building element for application as a roof or ceiling element. In particular the figure shows the profiled panel from the end 112. As is evident from FIG. 16b, the first variant is provided with holes of a circular configuration. In the second variant the holes are lined, e.g. with insulating materials or tightening materials, such as an inner coating. In the third variant the holes are of a rectangular configuration. In the fourth variant, the holes are located as a channel or tubular connection in a panel having either a flat bottom surface or a curved bottom surface.

Alternatively, each of the holes 122 may be configured as a square, an elliptical, a triangular or polygonal shape.

The holes may be fluid tight, i.e. watertight and also tight for oil or for other liquids as well. Accordingly, the holes may be applied for transporting any fluids.

The fluid may be a heated fluid, e.g. hot air, hot water or sun panel fluids. Accordingly, the building element may be used as a heating panel. Alternatively, or additionally. Additional holes may be used for a different purpose, e.g. for transporting a cooled or a cooling fluid, such as cold air or cold water. Accordingly, the building element may also be applied in air conditioning system and/or to cool down a building or building part.

In the four variants of the profiled building element shown in FIG. 16b, the number of holes 122 are preferably 5. Alternatively, the number of holes may be 3, 4, 6, 7, 8, 9, etc. Preferably, the channels or holes, which are located in the profiled channel housing and/or in the building element, may be mutually equidistantly spaced from the end 113 and the end 114. In another embodiment the holes or channels may alternatively be mutually equidistantly spaced between the end 111 and the end 112. Consequently, any two identical building elements fit together since the holes or channels of the one building element face the holes or channels of the other building element of the equally numbered channels or holes of the two building elements.

FIG. 16c shows an embodiment 101 of the building element, which may be applied to provide energy from the sun. Accordingly, the building element having basically the properties from embodiments shown in FIGS. 16a and 16b is provided with one or more solar cells 118 on top of the major surface 117. The channels or holes 122 may be applied to cool down the solar cells 118 to extend their life time by providing a constantly cool or cooled fluid through the holes or channels, alternatively the channels 122 may be applied to provide even more energy from the sun from a sun heated fluid running through the channels or holes.

Possibly the first connector 115 is of a bigger size than the size of the second connector 116. However, provided the thickness of the connectors 115 and 116 is very small, the connectors 115 and 116 may be of the same shape and size.

The two profiled connectors 115 and 116 may be integrally pultruded with the profiled panel in a single process.

The rectangular major surface 117 may be of a transparent material, or of a translucent material in any of the above described embodiments. Alternatively, or additionally in any of the above described embodiments, the major surface 117 may be provided with a layer of transparent polyester.

Alternatively, or additionally in any of the above described embodiments, the major surface 117 may be provided with a layer of a thermal insulating material 119; see FIGS. 17a and 17b, where FIG. 17a shows a building element in a top view, and FIG. 17b shows a building element in a side or end view.

Alternatively, or additionally the building element may be provided on top or below its major surface 117 with a layer of black polyester or dyed black polyester.

The function of the element is determined dependent on the intentional application, position and orientation (upright, slanted, vertical, horizontal, etc.) of the building element.

Furthermore, the use of the channels or holes 122 of the building element, e.g. which fluids are brought to flow, determines the functionality (heat, cold, air condition) of the building element.

However, some or all of the holes or channels 122 may be applied to running of pipes, electrical wires or cables, e.g. communication or computer control cables, antenna wires and the like. Alternatively, the channels or holes may be used to the running of a bowden cable for the control of mechanical movements, e.g. pulling or pushing of a machine part, e.g. a gear-mechanism, a clutch, a brake, etc.

FIG. 16d illustrates in greater details the parts constituting the building element 101. Basically, the building element 101 is constituted by the profiled panel 110, the profiled channel housing 121 and the two connectors 115 and 116. In order to have a flexible manufacturing plant it is important for logistic purposes that the parts 110, 115, 116 and 121 are provided together, e.g. extruded or preferably pultruded together. Alternatively, the parts 110, 115, 116 and 121 may be provided as individual parts or components.

In FIG. 16d, the profiled channel housing 121′ constitutes a separate housing part defining first and second ends 113′, 114′ and third and fourth ends 111′ and 112′ corresponding to the ends 113, 114, 111 and 112 of the profiled panel 110.

The profiled channel housing 121 may be assembled with the profiled panel 110 in two different ways.

Firstly, the ends 111′, 112′, 113′ and 114′ of the profiled channel housing 121 are positioned juxtaposed to corresponding respective ends 111, 112, 113 and 114 of the profiled panel 110. Hereby the connector 115 and the other parallel connector 116 are both parallel with the channels or holes 122 of the resulting building element 101.

Secondly, the ends 111′, 112′, 113′ and 114′ of the profiled channel housing 121 are positioned juxtaposed to corresponding respective ends 113, 114, 111 and 112 of the profiled panel 110. Hereby the connector 115 and the other parallel connector 116 are both orthogonal with the holes 122 or channels 122 of the resulting building element 101. In this second case where the channels 122 or holes 122 are orthogonal to the two connectors, the profiled channel housing 121 and profiled panel 110 are preferably pultruded or extruded in separate processes.

In another embodiment parts of the building element are provided from one pultruding equipment from one manufacturing site, i.e. the two profiled connectors 115 and 116 may be integrally pultruded with the profiled channel housing 121.

In another embodiment all parts of the building element are provided from one pultruding equipment from one manufacturing site, i.e. the two connectors 115 and 116 are integrally pultruded with the profiled channel housing 121 in conjunction—i.e. in the same process - with the profiled panel 110. Hereby the connectors 115 and 116 and the channels 122 all are parallel with one another in the resulting building element 101 as shown in FIGS. 16a, 16c, 17a, and 17b.

FIG. 18 illustrates how to fixate two building elements together. As illustrated, one or more of the channels 122 may be provided with a respective pipe 120. The pipe 120 is constructed to fit into a respective channel 122 of another building element. The building element 101 may be fixated to a surface, e.g. by means of a screw, a nail, etc., prior to or after the joining of the two building elements 101 together.

FIG. 19b illustrates two building elements prior to joining and fixating the building elements together, and FIG. 19a illustrates two building elements after joining and fixating. A pipe 120 extending from the channel 122 of the left-hand element is received in the channel 122 of the right-hand building element. A flange 123 of the right-hand building element extends parallel with the longitudinal axis of pipe 120 of the left-hand element and guides the left-hand element into the intentional joining of the two building elements.

The layer of thermal insulating material 119, which may be provided below or on top of the building element, or alternatively integrated in the building element, is in such case preferably selected among flexible materials so as to allow the surfaces orthogonal to the mentioned parallel sides to closely meet and abut one another.

FIG. 20 illustrates a building element applied as a ceiling or roof element. Heating fluid, e.g. warm water or another suitable fluid, e.g. heated gas, is provided to the inner of the building element by means of the insulated pipe 125 to a number of through-going holes 122′ orthogonal to through-going holes 122. The through-going holes 122′ are in fluid communication with the through-going holes 122. Accordingly the through-going holes 122′ are provided with respective inlet connections, and the through-going holes 122 are provided with corresponding outlet connections. Alternatively, the holes 122′ may be provided with outlet connections and the holes 122 may be provided with corresponding mating inlet connections.

FIG. 21a shows a wall element to be used as a heater by the supply of a fluid such as a warm liquid, e.g. heated water, to the wall element. The element of FIG. 20 is modified in that the pair of connectors 115 and 116 is not provided. Hereby a smooth surface constituted by joined wall elements is provided.

In FIG. 21b comparable inlet and outlet connections are shown constituted by pipes 124 and 126, respectively.

FIG. 21b shows an embodiment of a wall element constituting a heater. The inlet connection is designated the reference numeral 124, and the outlet connection is designated the reference numeral 126. The two connections may be interchanged in the embodiments shown in FIGS. 21a and 21b.

In FIGS. 22a and 22b, two alternative embodiments of the building element according to the present invention is shown. In FIG. 22a, the through-going pipes 122 are received with recesses 127 of the profiled channel housing 121, and on top of the profiled channel housing 121, the profiled panel 110 is positioned and sealed to the exposed outer top surfaces of the profiled channel housing 121 providing a structure in which the pipes 122 are freely received within through-going channels defined by the recesses 127. Alternatively, the pipes 122 may be arrested within the grooves or channels defined by the recesses 127 as the pipes 122 may be fixated e.g. by means of an adhesive to the profiled channel housing 121 or alternatively to the profiled panel 110.

In FIG. 22b, an alternative embodiment of the building element according to the present invention is shown in which the pipes 122 are embedded within the profiled channel housing 121 which is joined to the profiled panel 110. As distinct from the embodiment shown in FIG. 122a, the embodiment shown in FIG. 122b may be integrally pultruded as the pipes 122 may be integrally pultruded in the process of providing the profiled channel housing 121 in a single pultrusion process.

FIG. 22 shows the parts constituting the building element. As can be seen in the figure the channels 122 of the profiled channel housing 121 are not through-going tubular holes, however when the profiled panel 110 is joined, i.e. juxtaposed to the profiled channel housing 121 then the channels are closed, e.g. to be tubular for the transportation of any of the fluids mentioned. As a result, the channels 122 now define an identical number of through-going holes in the final building element 101.

Although the present invention has been described above with reference to a set of presently preferred embodiments, it is to be understood that the present invention may be modified in numerous ways without deviating from the inventive concept and idea as defined in the appending claims. Such amendments which will be evident to a person having ordinary skill in the art are to be contemplated part of the present invention.

1. A window element, comprising:
a first glass panel constituting an outer window pane of an overall rectangular configuration defining a first set of parallel sides and a second set of parallel sides,
a second glass panel constituting an inner window pane of an overall rectangular configuration substantially co-extensive with said first glass panel said second glass panel defining an inner window face,
a first and a second set of pultruded elements extending along said first and second set of parallel sides, respectively, and adhered to said first and second glass panels for interconnecting said first and second glass panels in a glazed window structure,
a window frame made of profiled pultruded elements circumferentially encircling said glazed window structure,
a set of co-operating hinged parts comprising a first part and a second part said first part being adhered to said window structure at a first edge parallel with one of said sides of said first set of sides, said second part being integrated into or constituted by one of said profiled pultruded elements of said window frame, and
a set of closure elements adhered to said inner window face of said second glass panel at a second edge parallel with another side of said first set of sides and co-operating with recesses provided in an adjacent profiled pultruded element of said window frame for arresting said window structure in a closed and sealed state.

2. The window element according to claim 1, wherein said first part of said set of co-operating hinged parts is adhered to at least one of said first glass panel and said second glass panel of said glazed window structure by means of an adhesive.

3. The window element according to claim 1, wherein said first glass panel extends beyond said first and second set of pultruded elements and seals against an outer circumferential rim of said window frame.

4. The window element according to claim 1, wherein each of said set of closure elements includes a handle operable for disengaging said closure elements from cooperating with a respective recess for allowing said window structure to be opened.

5. The window element according to claim 1, wherein said first and second set of pultruded elements includes a fibre material selected from the group consisting of glass fibres, carbon fibres, KEVLAR fibres, natural fibres and combinations thereof, wherein the fibres are joined by means of an adhesive material selected from the group consisting of epoxy. PU, thermosetting-adhesive, and hardening adhesive.

6. The window element according to claim 1, wherein said first and second sets of pultruded elements are adhered to said first and second glass panels by means of an adhesive selected from the group consisting of an epoxy adhesive and a PU adhesive.

7. The window element according to claim 1, further comprising a gas tight foil selected from a group consisting of aluminum foil and stainless steel foil providing a gas tight sealing of said first and second sets of pultruded elements relative to an inner space defined between said first and second glass panels.

8. The window element according to claim 1, wherein said glazed window structure is sealed off relative to said window frame by a sealing gasket.

9. A profiled pultruded panel for use as a wall covering of a building, said panel comprising:
an elongated, planar plate defining opposite first and second sides and a top edge and a bottom edge,
a set of profiled top and bottom flanges extending perpendicularly from said plate at said first side thereof along said top and bottom edges, respectively, said profiled top flange defining a top surface and said profiled bottom flange defining a bottom surface complementary to said top surface of said top flange, and
at least one further flange extending from said plate at said first side thereof from a position between said top and bottom flanges and defining an acute angle, relative to said plate and sloping downwardly towards said bottom edge,
wherein said planar elongated plate, said set of profiled top and bottom flanges and said at least one further flange are integrally produced in a pultrusion process.

10. The profiled pultruded panel according to claim 9, further comprising at least two further flanges extending from said plate at said first side thereof from positions equidistantly spaced from said top and bottom flanges and each defining an acute angle relative to said plate and extending mutually parallel.

11. The profiled pultruded panel according to claim 9, wherein each of said further flanges has an outermost end with a down-wardly protruding lip, and wherein each of said further flanges has, at a lower surface facing towards said bottom flange, an inner recess complementary to said down-wardly protruding lip.

12. The profiled pultruded panel according to claim 9, further including fixtures at said bottom surface for the fixation of an element selected from the group consisting of electrical cables, wires, heating tubes, water tubes, insulating panels, and combinations thereof.

13. The profiled pultruded panel according to claim 9, wherein the said bottom surface is provided with a micro-organism growth-preventing constituent.

14. A system comprising a profiled pultruded panel according to claim 9, and further comprising one or more fixation elements configured for fixating said profiled pultruded panel to a wall of a building, said one or more fixation elements each having a face plate and one or more outwardly pultruding and upwardly extending flanges configured complementary to said one or more further flanges.

15. The system according to claim 14, said one or more fixation elements being constituted by a segment of said profiled pultruded panel being turned upside-down.

16-19. (canceled)

20. A building element comprising:
a profiled panel defining a major surface of an overall rectangular configuration and defining parallel opposite first and second ends, and parallel opposite third and fourth ends,
a profiled channel housing defining a first set of opposite first and second sides jux-taposed said first and second ends of said profiled panel and defining a second set of opposite third and fourth sides juxtaposed said third and fourth ends of said profiled panel,
said building element having at said first and second side and/or end a respective first and second profiled connector, each of said first and second connectors extending between said third and fourth parallel sides and/or ends, said first and second connectors being matingly configured for allowing said first connector for an overlapping, resting and catching joining with another co-operating second connector of a matching shape of a second identical and adjacent building element, and allowing said second connector for a resting and catching joining with another co-operating overlapping first connector of a matching shape of a third identical and adjacent building element, and
said profiled channel housing comprising a number of identical and adjacent through-going channels, each of said channels extending between said first and second parallel ends and/or between said third and fourth parallel ends, said through-going channels alone or in combination with said profiled panel defining an identical number of through-going holes.

21. The building element according to claim 20, said profiled panel being pultruded integrally with said profiled channel housing.

22. The building element according to claim 20, said profiled panel and said profiled channel housing being separately pultruded prior to assembly of said building element.

23. The building element according to claim 20, said first and second profiled connector being integrally pultruded with said profiled panel.

24. The building element according to claim 20, said first and second profiled connector being integrally pultruded with said profiled channel housing.

25. The building element according to claim 21, said first and second profiled connector being integrally pultruded with said profiled channel housing and said profiled panel.

26. The building element according to claim 20, wherein the holes are fluid tight.

27. (canceled)

28. The building element according to claim 20, each of said holes defining a first and a second end, each hole having an inlet connection at said first end and an outlet connection at said second end.

29. The building element according to claim 20, wherein the building element is a heating panel.

30. The building element according to claim 20, wherein a solar cell panel is provided with solar cells on top of said major surface.

31. The building element according to claim 30 wherein the solar cell panel is provided with a layer of glass on top of said major surface.

32. The building element according to claim 20, wherein said first connector is of a bigger size than said second connector.

33. The building element according to claim 20, said number of holes being 2-10.

34. The building element according to claim 20, wherein each of said holes is configured for transporting heated fluids.

35. The building element according to claim 20, wherein each of said holes is configured for transporting cold or cooled fluids.

36. (canceled)

37. The building element according to claim 20, wherein said major surface is made of a transparent material.

38. The building element according to claim 20, wherein said major surface is made of a translucent material.

39. The building element according to claim 20, wherein said major surface is provided with a layer of transparent polyester.

40. The building element according to claim 20, wherein said major surface is joined to a layer of a thermal insulating material.

41. The building element according to claim 40, wherein said thermal insulating material is integral to said building element.

42. The building element according to claim 20, and being provided adjacent said major surface with a layer of black polyester.

43. (canceled)

44. The building element according to claim 20, one or more of said profiled panel, said profiled channel housing and said two profiled connectors being provided through a pultrusion process.

45. The building element according to claim 44, wherein said profiled panel, said profiled channel housing and said two profiled connectors are provided through a pultrusion process.

46. A method of producing a fibre reinforced building element comprising the steps of:
i) providing through a pultrusion process a profiled panel defining a major surface of an overall rectangular configuration and defining parallel opposite first and second ends and parallel opposite third and fourth ends,
ii) providing through a pultrusion process a profiled channel housing defining a first set of opposite first and second sides juxtaposed said first and second ends of said profiled panel and the profiled channel housing defining a second set of opposite third and fourth sides juxtaposed said third and fourth ends of said profiled panel,
iii) covering one of the major surface of said profiled panel and said profiled channel housing with reinforcing fibres and resin, said resin applied in the pultruding of at least one of said profiled panel and said profiled channel housing,
iv) positioning and aligning the two major surfaces of said profiled panel and said profiled channel housing onto one another with said reinforcing fibres and resin located between said two major surfaces, and
v) heating and curing said profiled panel and said profiled channel housing together so as to provide said fibre reinforced building element.

47. The method according to claim 46 further comprising the steps of:
vi) applying reinforcing fibres and resin on one of the two sets of parallel ends of the fibre reinforced building element, and
vii) heating and curing said fibres and resin on the respective two parallel ends of said fibre reinforced building element so as to provide said fibre reinforced building element with first and second profiled connectors.

48. A covering for a building comprising a plurality of systems as defined in claim 14, wherein the profiled pultruded panels of adjacent systems are positioned and fixed relative to each other by interconnections between said complementary top and bottom flanges of adjacent panels.

49. A building having the outer covering defined in claim 48.
